(19) United States
(12) Patent Application Publication
(10) Pub. No.: US 2021/0316396 A1
(43) Pub. Date: Oct. 14, 2021

(54) Laser Cutting Nozzle with Non-Rotatable Shroud

(71) Applicant: American Torch Tip Company, Bradenton, FL (US)

(72) Inventors: Steven Dadig, Palmetto, FL (US); Juan Renaldo Solis, JR., Bradenton, FL (US); Mark Rubio, Bradenton, FL (US)

(73) Assignee: American Torch Tip Company, Bradenton, FL (US)

(21) Appl. No.: 17/108,905

(22) Filed: Dec. 1, 2020

Related U.S. Application Data
(60) Provisional application No. 62/910,047, filed on Oct. 3, 2019.

(51) Int. Cl. B23K 26/14; B23K 26/38

(52) U.S. Cl. CPC B23K 26/1488; B23K 26/38

(57) ABSTRACT

According to an embodiment of a laser cutting nozzle where a shroud can move along the central axis of the laser cutting nozzle in the axial direction. The shroud is designed to mate with interior walls along a nozzle cavity extending from a cavity base of the nozzle body. The exterior side walls of the shroud and interior side walls of a cavity of the nozzle body are multi-sided (e.g., in complementary polygonal shapes). Shroud rotation about the central axis of the laser cutting nozzle is limited or prevented by an interlocking arrangement between the exterior side walls of the shroud and the interior side walls of the nozzle body.

### RELATED APPLICATIONS

This application claims the benefit of the filing date of U.S. Provisional Patent Application Ser. No. 62/910,047, filed on Oct. 03, 2019, entitled “Laser Cutting Nozzle with Non-rotatable Shroud” by Dadig et al., the entirety of which is incorporated herein by reference.

### BACKGROUND OF THE INVENTION

### Field of Invention

The present invention is in the technical field of laser cutting nozzles. More particularly, the invention relates to compound laser nozzles that have shrouds movable along an axial direction relative to a central axis but are designed to limit or prevent rotation of the shroud about the central axis which, in turn, prevents binding of the shroud during operation and helps to prevent swirling of the shielding gas flow passing through the shroud.

### Background of the invention

Laser cutting systems are commonly used to cut sheets of metal. These can be solid-state or gas-based laser systems, e.g., having CO₂ as the medium but, regardless of the type, a nozzle and lens system focus the laser beam and shielding gas on the workpiece.

The cut quality of a laser cutting system is a function of several variables relating to nozzle design. Generally, the nozzles function to focus the shielding gas, e.g., nitrogen, along a flow path to facilitate blowing melted metal away from the cut region once the work piece has been pierced or cut through. Some laser cutting systems also use the shielding gas to displace oxygen from the cutting surface to prevent oxidation during cutting, as oxidation can produce discoloration or other undesirable surface imperfections on the edges of the materials cut by a laser cutting system. Several nozzle designs are available for selection based on the workpiece materials.

Compound laser nozzles may include a shroud to create an enclosed volume below the nozzle through which the shielding gas flow forces out normal atmosphere. Compound laser nozzles can allow for a reduced amount of shielding gas flow when compared to a conventional nozzle which uses a larger nozzle orifice to flow a larger amount of shielding gas to the surface of the cutting piece and to displace oxygen from an open area around the cut location.

### SUMMARY OF THE INVENTION

The present invention provides a laser cutting nozzle that comprises a shroud which is movable along the nozzle axial direction, but the shroud is designed to not rotate about the central axis. By preventing the shroud from rotating about a central axis within the laser cutting nozzle, the flow of the shielding gas within the enclosed area of the shroud is not influenced by the mechanical rotation of the shroud, and swirling of the shielding gas flow is limited or prevented while passing through the shroud. Provision of anti-rotation features of the invention is based, in part, on recognition that, if the external geometries of the shroud and mating component are circular or annular, the flowing gas can begin swirling due to imperfections in the alignment of the shroud, lack of a perpendicularity to the work piece, or insufficient manufacturing tolerances of the nozzle or shroud. The shielding gas flow within laser cutting nozzles according to embodiments of the invention provides a higher gas velocity, and a perpendicular orientation to the work piece within the shroud volume. This results in less oxidation than a laser cutting nozzle having a rotatable shroud.

In one embodiment a laser cutting nozzle is formed about a central axis with a nozzle body having distal and proximal ends. A central bore of the nozzle body is colinear with the central axis of the nozzle. The nozzle body interior has a multi-sided cavity shape extending from the proximal end of the nozzle body to a cavity base of the nozzle body. A multi-sided shroud is designed to fit within the cavity of the nozzle body. A nozzle jet is mechanically attachable to the nozzle body in coalignment with the central bore and the central axis of the nozzle. The multi-sided shroud is movable in the axial direction, but movement is limited along the axial direction by the cavity base of the nozzle body and a retaining feature of the nozzle jet. In this embodiment the multi-sided shroud is prevented from rotation by interlocking it with an interior side wall or walls corresponding to a multi-sided cavity shape interior of the nozzle body.

In another embodiment a laser cutting nozzle is formed about a central axis with a nozzle body having distal and proximal ends. A machined feature of the nozzle body extends in the axial direction, about the central axis of the laser cutting nozzle, from the distal end of the nozzle body to a base of the nozzle body referred to as the cavity base. The machined feature includes a plurality of connected side walls which form a polygonal-shaped cavity about the central axis of the laser cutting nozzle. Adjacent ones in the plurality of side walls are interconnected at interior angles within the cavity of at least 30 degrees. In another embodiment, at least two of the side walls are parallel.

In still another embodiment of the invention a shroud for use in a laser cutting nozzle is formed along a central axis, having distal and proximal ends. When connected with the nozzle, the central axis of the shroud is co-linear with a central axis of the laser cutting nozzle, with the shroud sized to fit within a cavity of the nozzle body. When installed in the nozzle body the shroud rotation about the shroud central axis is limited or completely prevented but the shroud is free to undergo limited movement in the axial direction relative to the central axis.

### BRIEF DESCRIPTION OF THE DRAWINGS

Figures are not drawn to scale. The figures depict one or more embodiments, but the invention is not so limited.

FIG. 1 is an isometric view of a laser cutting nozzle in accordance with an embodiment of the present invention;

FIG. 2 is a view in cross section of the laser cutting nozzle of FIG. 1;

FIG. 2a is a view in cross section of the nozzle body of FIGS. 1 and 2;

FIG. 3 is an isometric view of an embodiment of a shroud suitable for incorporation within the laser cutting nozzle of FIGS. 1 and 2;

FIG. 4 is a rear view of the shroud seen in FIG. 3;

FIG. 5 is an isometric view of the nozzle body of FIGS. 1 and 2;

FIG. 6 is a front view of the nozzle body seen in FIG. 5;

FIG. 7 is a rear view of an embodiment of a shroud having 4 side walls;

FIG. 8 is a front view of an embodiment of the nozzle body having 4 side walls.

FIG. 9 is a rear view of an embodiment of a shroud having 5 side walls.

FIG. 10 is a front view of an embodiment of a nozzle body that having 5 side walls.

FIG. 11 is a rear view of an embodiment of a shroud having 6 side walls.

FIG. 12 is front view of an embodiment of a nozzle body having 6 side walls.

FIG. 13 is rear view of an embodiment of a shroud having 7 side walls.

FIG. 14 is front view of an embodiment of a nozzle body having 7 side walls.

FIG. 15 is rear view of an embodiment of a shroud having 8 side walls.

FIG. 16 is front view of an embodiment of a nozzle body having 8 side walls.

FIG. 17 is rear view of an embodiment of a shroud having 3 side walls.

FIG. 18 is front view of an embodiment of a nozzle body having 3 side walls.

FIG. 19 is a view in cross-section of an embodiment of the shroud seen in FIGS. 3 and 4.

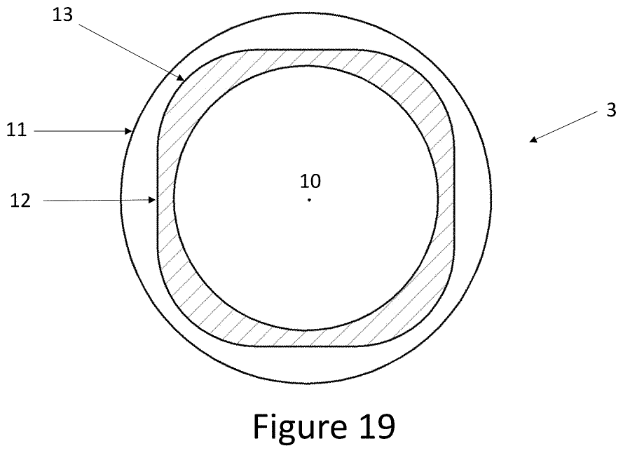

### DETAILED DESCRIPTION OF THE INVENTION

Referring now to the drawings, embodiments of the invention are shown wherein like reference numerals designate identical or corresponding parts for views of differing embodiments. The present invention is a laser cutting nozzle with a movable shroud that can move along the axial direction of the central axis of the laser cutting nozzle, but which cannot rotate about the central axis. The features presented in the various embodiments of the invention are interchangeable and are not limited to exclusive use in the presented embodiments.

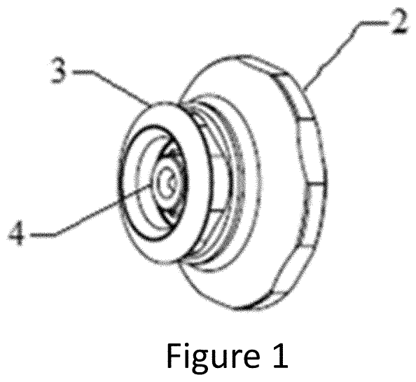

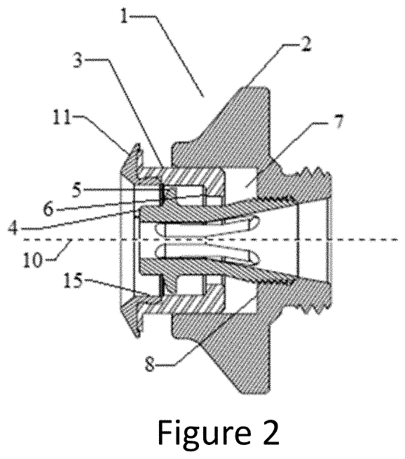

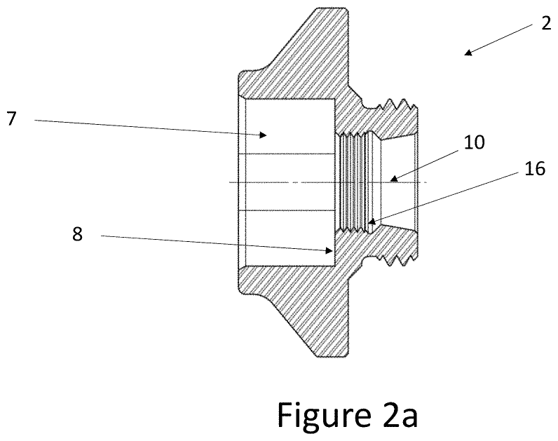

An isometric view and a view in cross section of an embodiment of the present invention are shown in FIGS. 1 and 2. A laser cutting nozzle 1 comprises a nozzle body 2, shroud 3 and nozzle jet 4. The shroud 3, designed to fit within a nozzle cavity 7 of the nozzle base 2 is able to move along a central axis 10 of the laser cutting nozzle 1, i.e., in axial directions, but the axial shroud movement limited in extent along the central axis 10 by the cavity base 8 of the nozzle body 2 and by a retaining feature 5 of the nozzle jet 4.

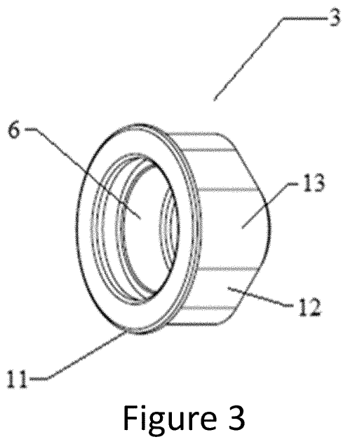

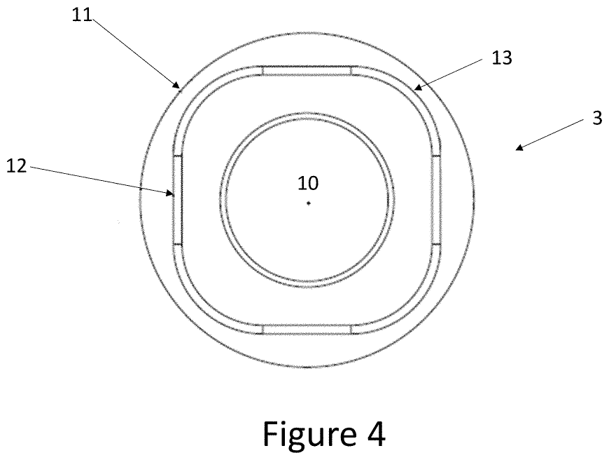

An embodiment of the shroud 3 is shown in the isometric view of FIG. 3 as having a multi-sided polygon shaped exterior with exterior side walls 12 that extend from a proximal to a distal end of the shroud 3 about the central axis 10 of the laser cutting nozzle 1. Shroud 3 contains an annular cavity 6 within the exterior side walls 12. Certain embodiments of the shroud 3 include a rim 11 that is mechanically attached to the distal end of the shroud 3 about the central axis 10, as seen in FIG. 3. The rim 11 can be manufactured from a different material than the shroud 3 or the shroud 3 can be manufactured to include the rim 11 in a single piece. A rear view of same embodiment of shroud 3 of FIG. 3 can be seen in FIG. 4. The outer side walls 12 of the shroud 3 are multi-sided, forming a polygonal shape. In this embodiment the multi-sided polygonal shape is a square, i.e. a four-sided polygon. Reference to square shapes herein includes embodiments which have straight polygonal sides intersecting at 90 degrees to create corner points at the intersections, but also includes embodiments where the corners have fillets 13. The shroud 3 is designed to mate with nozzle cavity 7 in the nozzle body 2 which has a multi-sided polygonal shape complementary to the annular cavity 6 of the shroud 3. See FIGS. 2 and 3. The mating and interlocking of the multi-sided polygonal shapes of shroud 3 and nozzle cavity 7 prevent the shroud 3 from rotating about the central axis 10 in the radial direction by the interference of the outer side walls 12 of the shroud 3 and the interior walls 14 of nozzle cavity 7 of the nozzle body 2. In this embodiment the illustrated intersections of adjoining outer side walls 12 have been rounded or as termed in drafting programs, fillet corners 13. The polygonal shapes defined by the outer side walls 12 of shroud 3 may comprise walls which are flat planes that intersect at vertices to create corners or may be planes comprising curves which create fillets about intersections of walls.

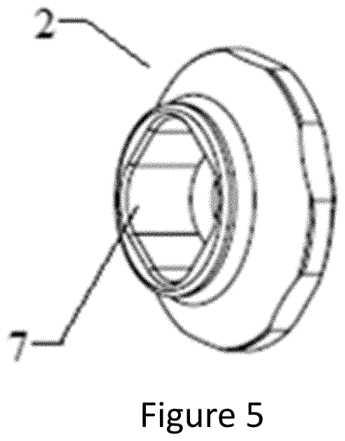

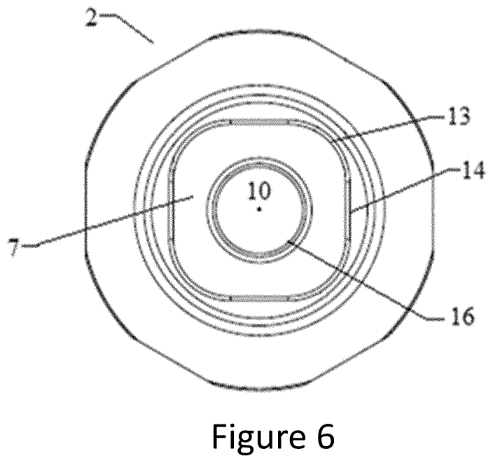

Still another embodiment of a nozzle body 2 in accord with the invention can be seen in the isometric view in FIG. 5 and the front view of the nozzle body 2 as shown in FIG. 6. The nozzle cavity 7 of the nozzle body 2 extends from a distal end to a proximal end of the nozzle body 2 about the central axis 10 of the laser cutting nozzle 1. The proximal end of the nozzle cavity 7 ends at the cavity base 8 of the nozzle body 2. See FIG. 2. The nozzle body 2 has a central bore 16 that extends from the cavity base 8 to the proximal end of the nozzle base 2 about the central axis 10. See FIGS. 2, 2a and 6. When the laser cutting nozzle 1 is assembled, the nozzle jet 4 is mechanically attached to the central bore 16 of the nozzle base 2. In certain embodiments the proximal end of the nozzle jet 4 and the central bore 16 of nozzle body 2 are mated together with threads. The nozzle cavity 7 has interior side walls 14 that form a multi-sided polygon sized and shaped to mate with shroud 3 along the nozzle cavity 7. In certain embodiments the nozzle cavity 7 is a machined feature but can be manufactured by other known methods such as casting, sintering, forging, or other metal working technique. In this embodiment the multi-sided polygonal shape is square, i.e., a four-sided polygon, where the intersections of the interior side walls 14 have been rounded or as termed in drafting programs, fillet corners 13. The polygonal shapes defined by the interior side walls 14 of the nozzle cavity 7 may comprise walls which are flat planes that intersect at vertices or may be planes comprising curves to provide fillets about the intersections as shown in the figures.

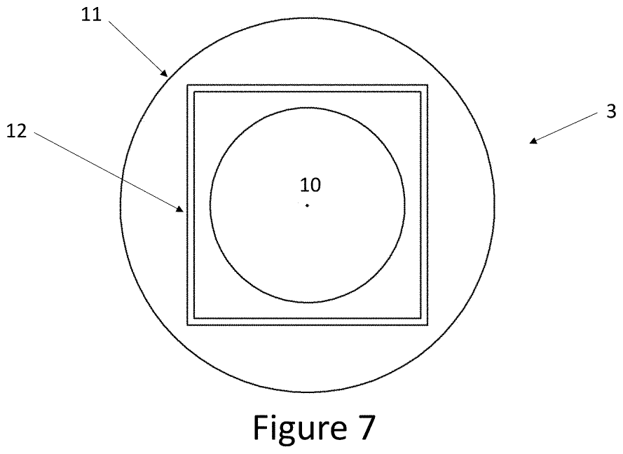

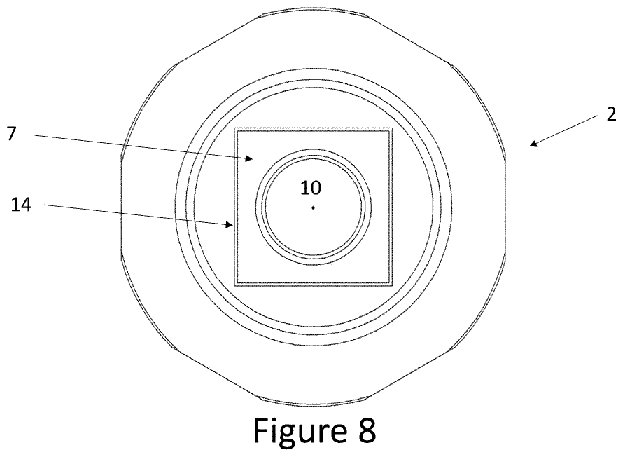

FIG. 7 shows an embodiment of the invention that has a shroud 3 with a four-sided polygonal shape (i.e., a square) for outer side walls 12. FIG. 8 shows an embodiment of the nozzle body 2 that has interior side walls 14 with a four-sided polygon, i.e., square, shape that define nozzle cavity 7. The interior angle between the intersecting side walls (i.e., the sides facing the central axis 10), is a right angle (90 degrees). That is, flat polygonal sides are shown intersecting at 90 degree angles to create points, e.g., the illustrated square corners provide points or vertices at intersections rather than rounded corners, i.e, fillets.

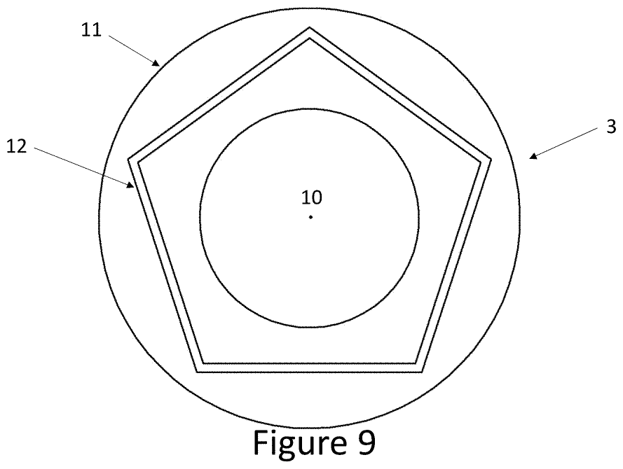

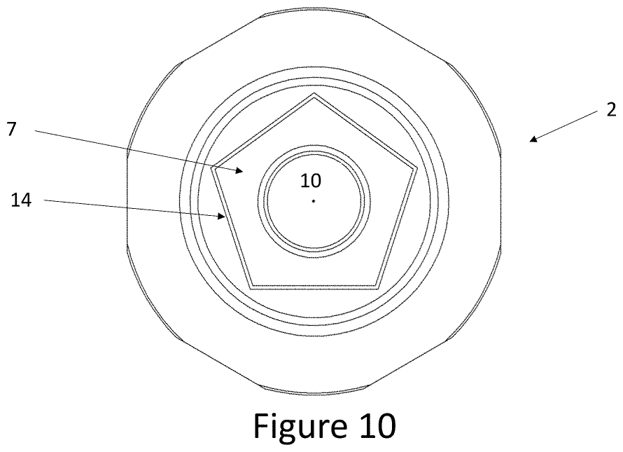

FIG. 9 shows an embodiment of the invention where the shroud 3 has outer side walls 12 in the shape of a five-sided polygon, i.e., a pentagon. FIG. 10 shows an embodiment of the nozzle body 2 that has interior side walls 14 with a five-sided polygonal (i.e., pentagonal,) shape that define the nozzle cavity 7. The interior angles at the intersections between the adjoining side walls (i.e., facing the central axis 10) are 108 degrees.

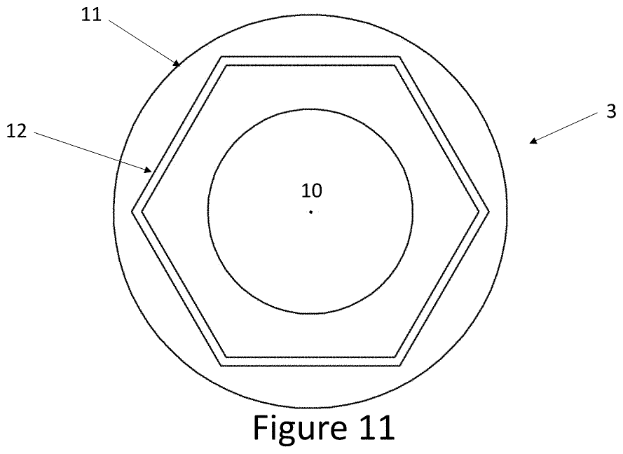

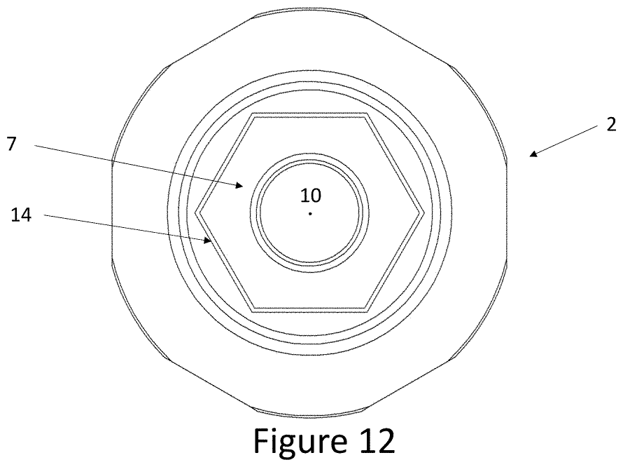

FIG. 11 illustrates an embodiment of the invention having a shroud 3 with a six-sided polygonal shape, i.e., hexagonally shaped outer side walls 12. FIG. 12 shows an embodiment of the nozzle body 2 that has interior side walls 14 forming a six-sided polygonal shape that define nozzle cavity 7. The interior angles at the intersections between of the adjoining side walls (i.e., facing the central axis 10) are 120 degrees.

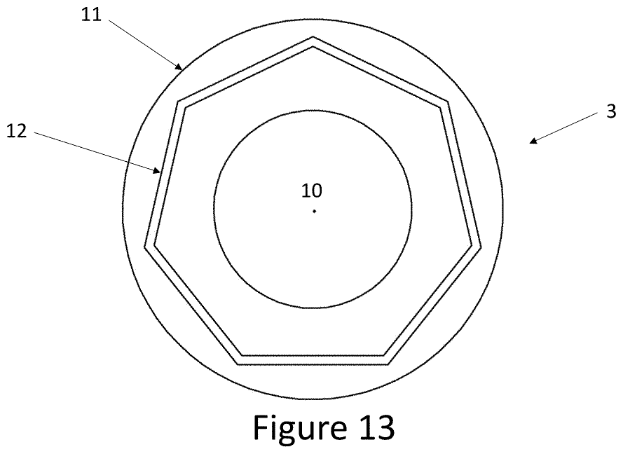

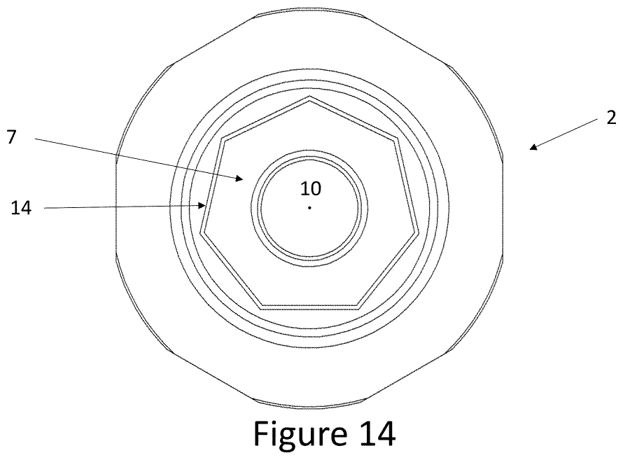

FIG. 13 illustrates an embodiment of the shroud 3 having a seven-sided polygonal shape, (i.e., heptagonally shaped outer side walls 12). FIG. 14 illustrates an embodiment of the nozzle body 2 that has interior side walls 14 forming a seven-sided polygonal, i.e., heptagonal, shape that define nozzle cavity 7. The interior angle between adjoining ones of the side walls (i.e., facing the central axis 10) are 128.57 degrees.

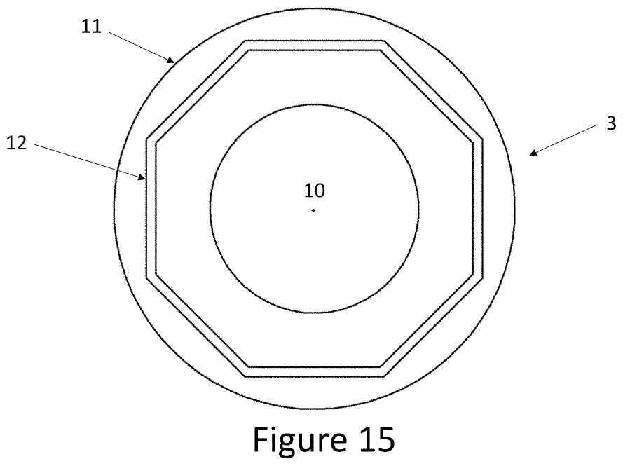

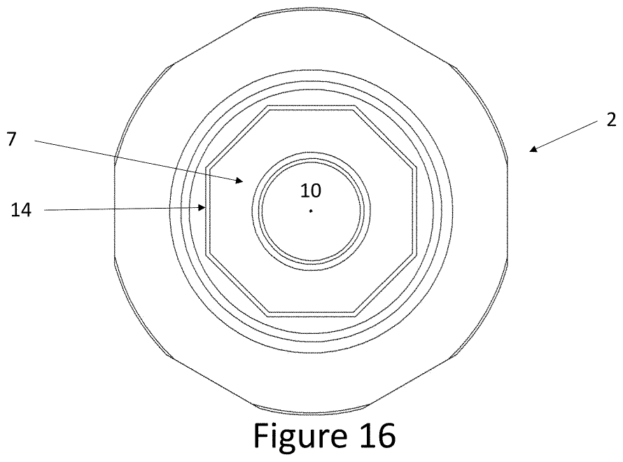

FIG. 15 shows an embodiment of the invention where the shroud 3 is in the shape of an eight-sided polygon, i.e., octagon-shaped outer side walls 12. FIG. 16 shows an embodiment of the nozzle body 2 that has interior side walls 14 with an eight-sided polygon, i.e., octagonal, shape that defines nozzle cavity 7. The interior angle between the adjoining side walls (i.e., facing the central axis 10) are 135 degrees.

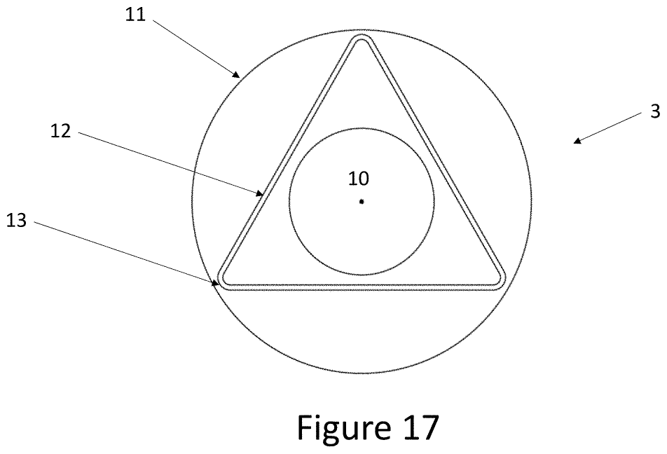

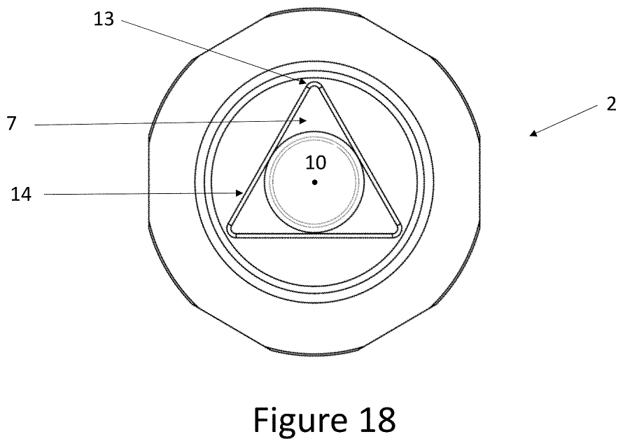

FIG. 17 shows an embodiment of the invention where the shroud 3 is in the shape of a three-sided polygon, i.e., triangle-shaped outer side walls 12. FIG. 18 shows an embodiment of the nozzle body 2 that has interior side walls 14 with a three-sided polygon, i.e., triangular, shape that defines nozzle cavity 7. The interior angle between the adjoining side walls (i.e., facing the central axis 10) are 60 degrees.

The geometries defined by the interior side walls 14 of the nozzle cavity 7 and the outer side walls 12 of the shroud 3, i.e., interlocking shapes, are not limited to the disclosed polygonal shapes. Any interlocking shapes, including asymmetrical or free form shapes, are contemplated.

1. A laser cutting nozzle comprising:
a nozzle body formed about a central axis and having distal and proximal ends, a central bore colinear with a central axis of the laser cutting nozzle, the bore including a multi-sided cavity extending from the proximal end of the nozzle body to a cavity base of the nozzle body,
a multi-sided shroud which fits within the multi-sided cavity, and a nozzle jet mechanically attachable to the nozzle body along the central bore,
wherein the multi-sided shroud is able to move in the axial direction along the central axis of the laser cutting nozzle with movement in the axial direction limited in range by the cavity base and a retaining feature of the nozzle jet; and rotational movement is limited or prevented about the central axis of the laser cutting nozzle by an interlocking arrangement of the multi-sided cavity and the multi-sided shroud.

2. The laser cutting nozzle of claim 1 wherein the multi-sided cavity has at least three interior side walls and the multi-sided shroud has at least three exterior side walls.

3. The laser cutting nozzle of claim 1 wherein at least two of the interior side walls of multi-sided cavity and at least two of the exterior side walls of the multi-sided shroud are parallel to one another.

4. The laser cutting nozzle of claim 1 wherein the intersections of adjoining interior side walls defining the multi-sided cavity and the exterior side walls of the shroud have rounded corners.

5. The laser cutting nozzle of claim 1 wherein the intersections of adjoining interior side walls of the multi-sided cavity and the intersections of adjoining exterior side walls of the shroud are vertices defined by intersections of the flat walls.

6. The laser cutting nozzle of claim 1 wherein the multi-sided shroud further comprises a mechanically attached rim along an edge at the distal end of the multi-sided shroud positioned about the central axis.

7. A nozzle body for use in a laser cutting nozzle where the nozzle body includes distal and proximal ends formed along a central axis thereof, the nozzle body comprising a machined feature extending in the axial direction along the central axis of the nozzle body, from the distal end of the nozzle body to a cavity base, the machined feature including a plurality of adjoining walls which form a polygonally shaped cavity centered about the central axis of the nozzle body.

8. The nozzle body of claim 7 wherein the plurality of walls of the polygonally shaped cavity have an interior angle of at least 30 degrees between adjoining ones in the plurality of walls when facing the central axis.

9. The nozzle body of claim 7 where the polygonal-shaped cavity is square shaped.

10. The nozzle body of claim 7 wherein at least two of the plurality of walls of the polygonal-shaped cavity are parallel.

11. The nozzle body of claim 7 wherein the intersections of adjoining ones in the plurality of walls of the polygonal-shaped cavity are rounded.

12. The nozzle body of claim 7 wherein the intersections of adjoining ones in the plurality of walls of the machined feature are vertices defined by intersections of the flat walls.

13. A shroud for use in a laser cutting nozzle, the shroud formed as a hollow body having a polygonal shape formed along a central axis, the hollow body comprising a series of adjoining walls and having distal and proximal ends, wherein the shroud, when installed within the laser cutting nozzle, cannot freely rotate about the nozzle.

14. The shroud of claim 13 further comprising a continuous rim mechanically attached along the distal end of the shroud.

15. The shroud of claim 13 wherein the shroud can move in an axial direction along the central axis when installed in the laser cutting nozzle.

16. The shroud of claim 13 wherein the shroud is designed to mate within a nozzle body of the laser cutting nozzle by insertion within a cavity formed in the nozzle body.

17. The shroud of claim 16 wherein rotation of the shroud about the central axis is limited or prevented with respect to rotation of the nozzle body by an interlocking of at least one external surface feature of the shroud and at least one internal surface feature of the nozzle body.

18. A laser cutting nozzle comprising the nozzle body of claim 6.

19. A laser cutting nozzle comprising the shroud of claim 12.
